(19) United States
(12) Patent Application Publication
(10) Pub. No.: US 2015/0048952 A1
(43) Pub. Date: Feb. 19, 2015

(54) METHOD OF MONITORING A HEALTH STATUS OF A BEARING WITH A WARNING DEVICE IN A PERCENTAGE MODE

(71) Applicant: AKTIEBOLAGET SKF, Göteborg (SE)

(72) Inventor: Jonathan David Murphy, Friday Harbor, WA (US)

(21) Appl. No.: 14/372,596

(22) PCT Filed: Dec. 21, 2012
(86) PCT No.: PCT/US2012/070253

§ 371 Date: Jul. 16, 2014

Related U.S. Application Data
(60) Provisional application No. 61/578,478, filed on Dec. 21, 2011.

(51) Int. Cl. G01M 1/22; G01M 13/04; G08B 21/18

(52) U.S. Cl. CPC G01M 1/22; G08B 21/182; G01M 13/045
USPC 340/682

(57) ABSTRACT

A rotational element monitoring process (700) utilizing a machine condition indicating sensor and monitoring device (100) adapted to a rotating machine (410). The process (700) monitors at least one operating characteristic of a rotating element of a rotating machine. The operating characteristics can include velocity (500), acceleration (500), temperature (600), etc. The process (700) establishes a baseline value (524, 624) for each operating characteristic. An alarm threshold (530, 630) is determined by either a predetermined percentage difference (540) or a predetermined quantified delta (640). The device establishes a measurement schedule (740) retaining the device in a sleep mode (740) and pulsing a condition investigation in accordance with a frequency. The frequency increases (742) when approaching or exceeding an alarm condition. The device (100) indicates an alarm condition by illuminating an alarm indicating light (220, 222, 224).

### CROSS-REFERENCE TO RELATED APPLICATION

This Application is being submitted under the Patent Cooperative Treaty and claims the benefit of co-pending U.S. Provisional Patent Application Ser. No. 61/578,478, filed on Dec. 21, 2011.

### BACKGROUND OF THE INVENTION

1. Technical Field of the Invention

The present disclosure generally relates to a method for monitoring a health status of a bearing with a warning device preset into a percentage mode. More particularly, the present disclosure relates to a method for monitoring a health status of a bearing with a warning device preset into a percentage mode having sensors detecting changes in temperature, acceleration and velocity and displaying an alarm condition when detected.

2. Background Art

A bearing can be defined as any of various machine elements that constrain the relative motion between two or more parts to only the desired type of motion. This is typically to allow and promote free rotation about a longitudinal axis and/or restrain any linear movement of a component in a normal direction respective to the bearing. Bearings may be classified broadly according to the motions they allow and according to their principle of operation, as well as by the directions of applied loads they can handle.

Bearings undergo significant use, which causes wear to the various bearing components. Over time, the wear on the bearing can result in mechanical failure. Mechanical failure can impact the rotational motion and/or the axial linear restraint. Failure to control either of these movements can cause catastrophic failure to the machinery relying upon the bearing.

Bearing reliability and predictive servicing can impact the operation and uptime of equipment. Bearings are used in many applications, including vehicles, wind turbines, automated machinery, and the like. Over time, the bearings wear. Bearing failure during operation can cause significant damage to the equipment and possibly the surrounding area. The bearing failure could even potentially cause injury or death to people should the right circumstances come occur.

The processes for monitoring bearings can vary. A majority of the machines requiring monitoring are remotely located, wherein providing power to a proposed monitoring system would be difficult, costly, and could impact reliability of the equipment and monitoring system.

Several items can impact the efficiency and reliability of rotating machinery. These can include contamination, wear, thermal degradation, a shift in alignment, an imbalance, a vibration, and the like.

Bearing reliability and predictive servicing can be improved by monitoring the bearing. What is desired is a low cost, low power consuming rotating machine monitoring device that indicates a pending or current reliability risk or operational failure.

### DISCLOSURE OF THE INVENTION

The present invention is directed towards a monitoring device and respective method for monitoring a condition of elements integrated into one or more rotating portions(s) of a rotating machine, wherein the monitoring device monitors one or more functions and determines a potential or current reliability and operational concern by comparing a current status reading against a threshold calculated based upon a percentage difference from an established baseline data point.

In a first aspect of the present invention, a method of monitoring a condition of at least one rotating component of a rotating machine, the method comprising steps of:

installing a machine condition indicating sensor and monitoring device, the device comprising:
a sensor housing comprising a base subassembly and an upper enclosure,
a printed circuit assembly defining an operational circuit, the operational circuit comprising a microprocessor, a digital memory component, a portable power supply, at least one condition sensor, and an instruction set, wherein the instruction set directs operation of the circuit by the microprocessor;

obtaining at least one data point of at least one operating characteristic of the respective rotating component to determine an initial baseline of each of the at least one operating characteristic of the rotation machine;

storing the initial baseline within the memory component;

establishing a threshold, wherein the threshold is calculated as a percentage difference from the respective baseline;

monitoring each respective at least one operating characteristic of the respective rotating component during operation of the rotating machine;

comparing currently obtained condition data of each respective at least one operating characteristic of the respective rotating component against the calculated threshold to determine is the currently obtained condition is one of approaching an alarm condition and exceeding an alarm condition; and

based upon the output of the comparison between the currently obtained condition data and the respective stored baseline data, proceeding with one of:

in a condition where the percentage difference is less than the calculated threshold, the machine condition indicating sensor and monitoring device continues to monitor conditions of the respective rotating component, and

in a condition where the percentage difference is greater than the calculated threshold, the machine condition indicating sensor and monitoring device indicates an alarming condition.

In a second aspect, the at least one operating characteristic is selected from an operating characteristic group, the operating characteristic group comprising a velocity, acceleration, and a temperature of the respective rotating component.

In another aspect, the threshold is calculated using a percentage difference in accordance with the following formula:

Threshold=baseline+(baseline*pre-established factor),

where the pre-established factor corresponds to a percentage. In one example, the pre-established factor would be 2.0, representative of 200%.

In yet another aspect, the device further includes at least one light emitting diode (LED), wherein the LED indicates an alarming condition.

In yet another aspect, the device further comprises a proximity programming interface.

In yet another aspect, the device further comprises a magnetic programming interface.

In yet another aspect, the device further comprises a user interface for indicating when an alarm condition is identified.

In yet another aspect, the user interface comprises at least one light emitting diode (LED).

In yet another aspect, the user interface comprises at least one multi-color light emitting diode (LED).

In yet another aspect, the user interface comprises at least one tri-color light emitting diode (LED).

In yet another aspect, the user interface comprises a plurality of light emitting diodes (LED's), each LED emitting a different color.

In yet another aspect, the portable power supply is a battery. The preferred battery is a lithium battery.

In yet another aspect, operation of the device includes a time delay, wherein the time delay introduces a span of time between data collection points. The time delay reduces power consumption.

In yet another aspect, the time span of the time delay is reduced when the device determines that the monitored device is one of approaching and exceeding an alarm condition.

In yet another aspect, the device proceeds with at least one data measurement upon initial identification of an alarm condition to verify the machine is in an alarm condition.

In yet another aspect, the device proceeds with a series of data measurements take over a predetermined period of time to verify the machine is in an alarm condition.

In yet another aspect, the device determines a velocity of a rotational object by monitoring acceleration.

In yet another aspect, the device includes a coupling feature incorporated into the base section.

In yet another aspect, the enclosure and respective base forms an environmental barrier between the electronic components and the elements of the environment.

In yet another aspect, the device further comprises a thermal coupling between the monitored device and at least one integrated temperature sensor.

In yet another aspect, the thermal coupling is provided through the base member.

In yet another aspect, the device further comprises a barcode or other machine-readable indicia. The barcode can be located upon a side surface of the enclosure, a top surface of the enclosure or any other accessible or visible region of the device.

In yet another aspect, the device can determine the calculated threshold by adding a quantified differential to the baseline value.

In another aspect, the threshold is calculated utilizing a quantified differential in accordance with the following formula:

Threshold=baseline+pre-established quantified differential

In another aspect, the device can be programmed to include capabilities of determining a threshold using both the percentage calculations and the quantified differential calculations.

In another aspect, the device can be programmed to selectively operate using one of the percentage calculations and the quantified differential calculations.

One advantage of the present invention is the ability to monitor a rotating element of a rotating machine using a low cost, low power consuming device. The device is self-contained and can include one or more light emitting elements to communicate a status to an operator.

The machine condition indicating sensor and monitoring device provides an economical solution for monitoring non-critical machines. The machine condition indicating sensor and monitoring device can be installed into machines that are commonly subjected to constant operating conditions. The output of the machine condition indicating sensor and monitoring device provides a simple and clear indicator, wherein an alarm condition is identified by emitting an indicating light.

Another advantage incorporates a frequency schedule for investigating one or more conditions of a rotating element of a rotating machine. The frequency obtains readings of the predetermined operating characteristics of the rotating machine at predetermined time intervals, placing the device in a sleep mode between readings. The sleep mode significantly reduces power consumption, thus extending the life of the battery.

Another advantage is an inclusion of intelligence. The device would identify when the rotating machine is approaching an alarming condition. As one or more conditions of the rotating machine approach an alarming condition, the device can increase the frequency of data collection measurements to ensure the alarm condition is identified as soon as possible. The device includes intelligence for modifying the frequency of data collection measurements, wherein the frequency is increased when the device detects that the machine is approaching or exceeds an alarm condition. The ability to modify the frequency of measurements or time span of the sleep mode optimizes the monitoring process and power conservation.

The machine condition indicating sensor and monitoring device can monitor velocity, enveloped acceleration, temperature, and the like to determine the overall health condition of a machine, including bearing degradation, misalignments, off balanced conditions, and the like.

The machine condition indicating sensor and monitoring device includes intelligence to minimize or avoid false alarms. The machine condition indicating sensor and monitoring device can be utilized to alert for predictive maintenance.

The device can be programmed by a proximity device, such as a magnetic read key. The utilization of a proximity device for programming ensures the device remains sealed against contamination or other degrading exposure to the environment.

These and other features, aspects, and advantages of the invention will be further understood and appreciated by those skilled in the art by reference to the following written specification, claims and appended drawings, which follow.

### BRIEF DESCRIPTION OF THE DRAWINGS

For a fuller understanding of the nature of the present invention, reference should be made to the accompanying drawings in which:

FIG. 1 presents an elevated isometric view of an exemplary machine condition indicating sensor and monitoring device and respective magnetic coded key in accordance with a preferred embodiment of the present invention;

FIG. 2 presents a bottom side view of the machine condition indicating sensor and monitoring device originally introduced in FIG. 1;

FIG. 3 presents an elevated isometric view of the machine condition indicating sensor and monitoring device originally introduced in FIG. 1, the illustration having the body removed to present details of the operational components thereof;

FIG. 4 presents a partial cross-sectioned isometric view of the machine condition indicating sensor and monitoring device originally introduced in FIG. 1;

FIG. 5 presents a partial plan view of an exemplary inner bearing raceway having 3rd order defects;

FIG. 6 presents an exemplary schematic diagram representative of an industrial environment comprising a plurality of rotating machines, each machine being configured having the machine condition indicating sensor and monitoring device originally introduced in FIG. 1 integrated therewith, wherein the illustration presents an exemplary manual status inspection process;

FIG. 7 presents an exemplary velocity condition monitoring chart representative of a percentage monitoring process;

FIG. 8 presents an exemplary temperature status monitoring chart representative of an absolute delta monitoring process;

FIG. 9 presents an initialization portion of a percentage monitoring flow diagram describing an exemplary a machine condition indicating sensor and monitoring device configuration and initiation process; and

FIG. 10 presents a monitoring and alarming portion of the percentage monitoring flow diagram describing an exemplary a machine condition indicating sensor and monitoring device operational data collection process, data analysis process, and alarm consideration step(s).

Like reference numerals refer to like parts throughout the several views of the drawings.

### MODES FOR CARRYING OUT THE INVENTION

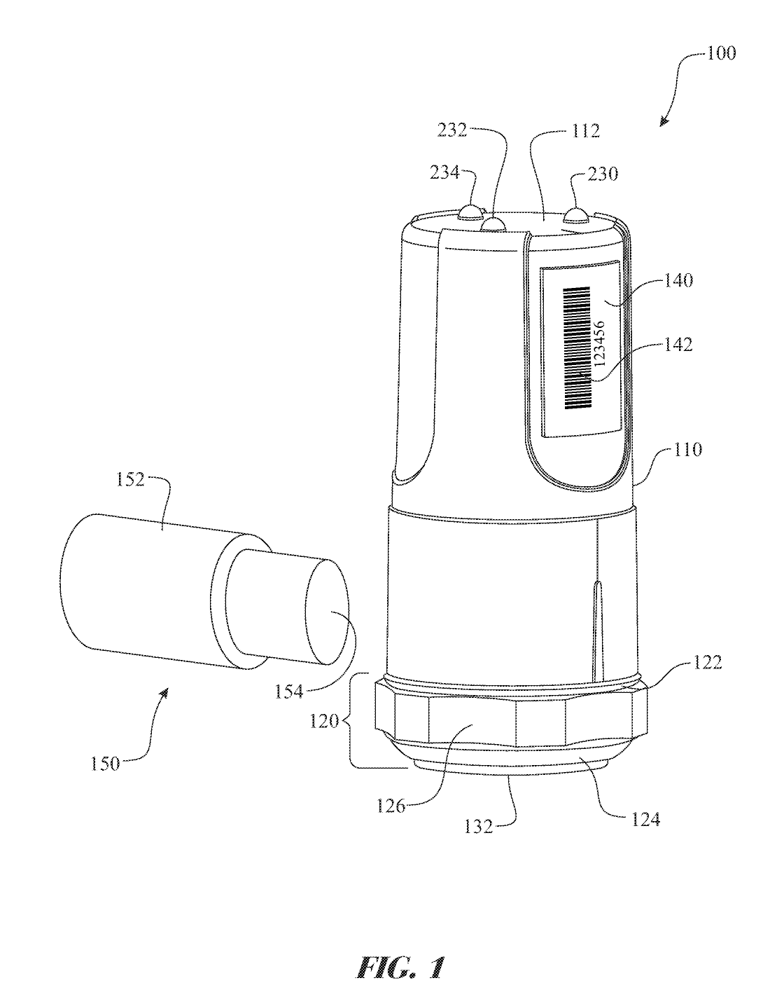

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

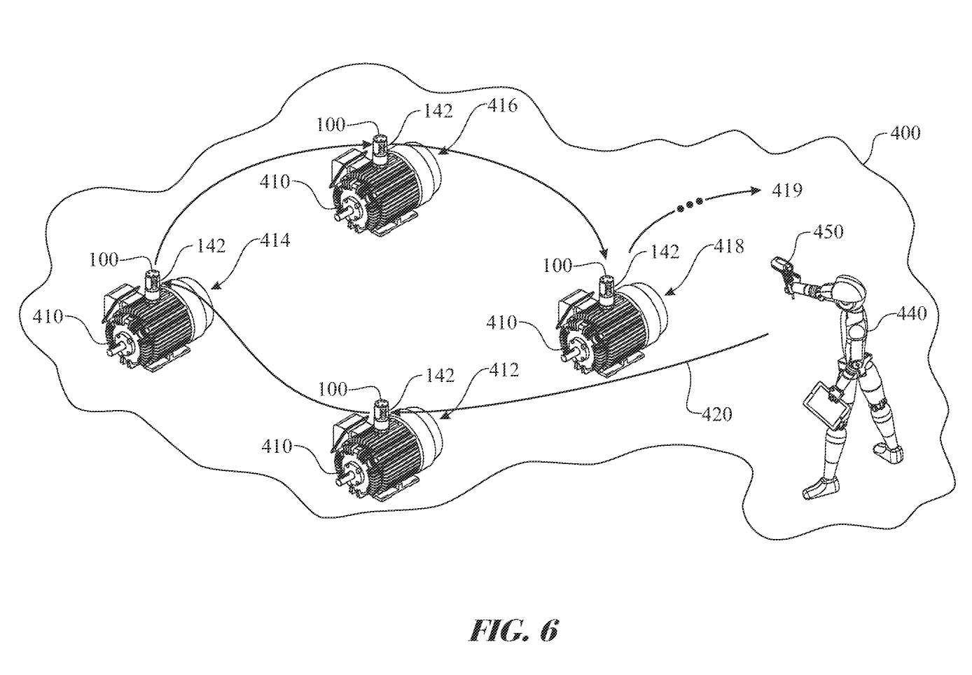

An exemplary machine condition indicating sensor and monitoring device 100 is presented in FIGS. 1 through 4. The machine condition indicating sensor and monitoring device 100 can alternatively be referred to as a machine condition indicator. The machine condition indicating sensor and monitoring device 100 is designed to be attached to a rotating industrial machinery 410 (FIG. 6) to monitor a condition of a rotation member of the rotating industrial machinery 410. The machine condition indicating sensor and monitoring device 100 includes sensors 220, 222, 224 to obtain condition data of the rotating member. The machine condition indicating sensor and monitoring device 100 can be configured to utilize a percentage difference between a baseline data set and a current status data set of the rotating member to determine whether the rotating member is approaching or currently experiencing a concerning condition that needs attention. Alternatively or in combination, the machine condition indicating sensor and monitoring device 100 can be configured to utilize a quantified delta between the baseline data set and a current status data set of the rotating member to determine whether the rotating member is approaching or currently experiencing a concerning condition that needs attention. Typical applications for the machine condition indicating sensor and monitoring device 100 include motors, fans, conveyors, pumps, drive shafts, compressors, gear assemblies, and the like.

The machine condition indicating sensor and monitoring device 100 is configured having external structure to support and protect operational electrical components retained within an interior cavity thereof. The external structure additionally includes a mounting interface for attaching the machine condition indicating sensor and monitoring device 100 to the rotating industrial machinery 410 or other rotating element.

The external structure can be segmented into a sensing device enclosure 110 and a base subassembly 120. The sensing device enclosure 110 is fabricated having a tubular sidewall extending between a base attachment end 120 and a distal end. A distal end of the sensing device enclosure 110 can be sealed by any reasonable manner. The exemplary embodiment integrates an annular top member 112 into the design, wherein the annular top member 112 provides a seal about a distal opening of the sensing device enclosure 110. This configuration enhances a manufacturing process of the machine condition indicating sensor and monitoring device 100. A series of alarm indicators, provided as one or more light emitting diodes (LED's) 230, 232, 234, attached to the annular top member 112. The sensing device enclosure 110 is slideably assembled over the annular top member 112, wherein the annular top member 112 seats against an interior seal (not shown) provided about the distal end thereof. The sidewalls, distal end, and attachment end of the sensing device enclosure 110 can include any of a variety of features to improve the assembly of the machine condition indicating sensor and monitoring device 100, aesthetics of the machine condition indicating sensor and monitoring device 100, and the like.

The base subassembly 120 is assembled to an attachment end of the sensing device enclosure 110. A base support and seal feature 128 is provided upon an interior surface of the base subassembly 120. The base subassembly 120 can incorporate features to engage with a respective end of the sensing device enclosure 110. A PCB support slot 129 can be formed spanning across the base support and seal feature 128 for receiving and supporting a Printed Circuit Assembly (PCA) 200. The base subassembly 120 includes a base seal 122, which creates an environmental barrier between the base subassembly 120 and the rotating industrial machinery 410. The base seal 122 can include a base seal ring 132 in a form of a raised annular ring. The base subassembly 120 is used to mount the machine condition indicating sensor and monitoring device 100 to the rotating industrial machinery 410. The base seal 122 includes a base seal element 124. The base seal element 124 is preferably fabricated of a planar material that sufficiently supports a threaded through hole 130. The threaded through hole 130 is preferably in axial registration with a rotational axis of the base subassembly 120. The base seal ring 132 can be integrated as a component providing thermal transfer between the rotating industrial machinery 410 and the temperature sensor 220, 222.

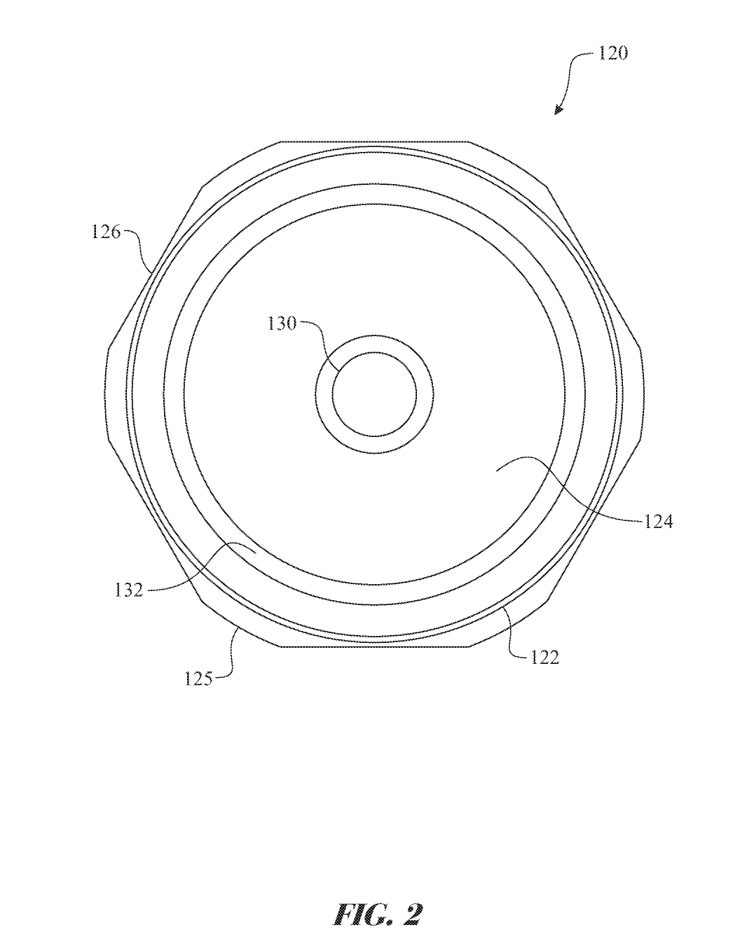

An attachment feature, such as a threaded through hole 130, is integrated into the base subassembly 120 for attachment to the rotating industrial machinery 410. In an embodiment incorporating the threaded through hole 130, it is understood that the threaded through hole 130 can be provided having any suitable thread size. Typically, a stud runs up through a clearance hole drilled in the rotating industrial machinery 410. The threaded through hole 130 can be threadably attached to a stud installed upon the rotating industrial machinery 410. Alternatively, the threaded through hole 130 can be adapted from a female configuration to a male configuration by inserting a threaded stud (not shown) therein. The installation can utilize any of variety of threaded studs to adapt the machine condition indicating sensor and monitoring device 100 to a pre-established threaded receptacle. The base subassembly 120 includes an installation tool interface 125 for aiding the installation process. The exemplary installation tool interface 125 includes is provided in a form of an annular ring comprising a plurality of installation grip surfaces 126, wherein the installation grip surfaces 126 form a hexagonal shape (as best shown in a bottom, base view illustrated in FIG. 2) for installation and tightening with an installation tool (not shown). It is understood that the installation tool interface 125 can be shaped in any configuration suitable for engagement with a respective installation tool, such as having two parallel installation grip surfaces 126, a square shape, a star shape, and the like. The preferred base subassembly 120 is fabricated of a metallic material. The metallic material provides suitable thermal transfer, long term reliability, malleability, and the like.

The threaded through hole 130 provides on attachment interface for attaching the base subassembly 120 to the rotating industrial machinery 410. It should be noted that there are many other potential configurations for mounting the machine condition indicating sensor and monitoring device 100 to the rotating industrial machinery 410 that can be contemplated by one skilled in the art. It is understood that epoxy or any other bonding agent may be employed for attaching the base subassembly 120 to the rotating industrial machinery 410. It would be preferred that the bonding agent be thermally conductive.

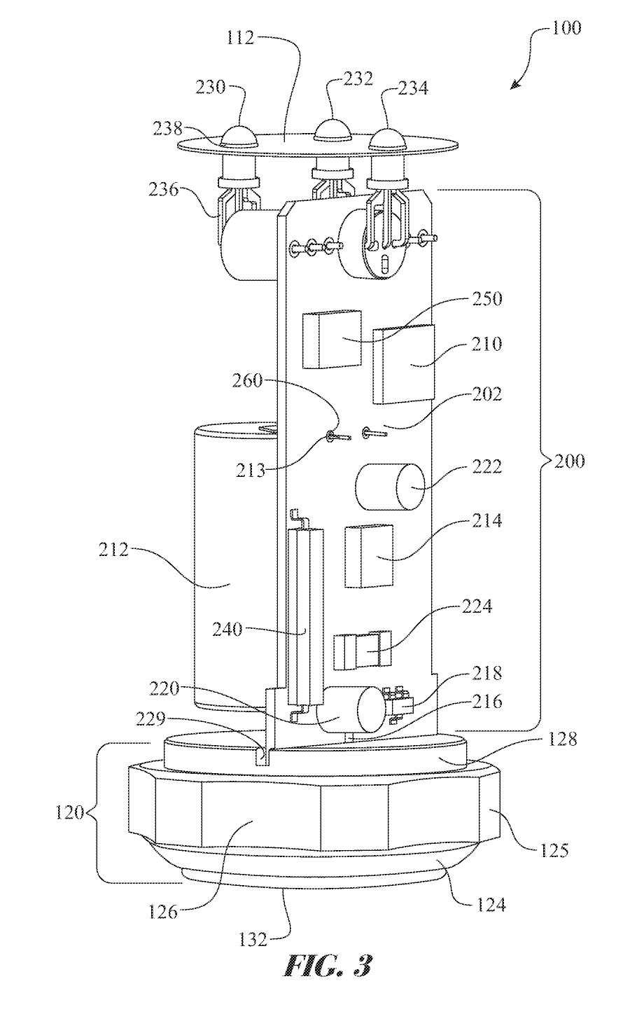

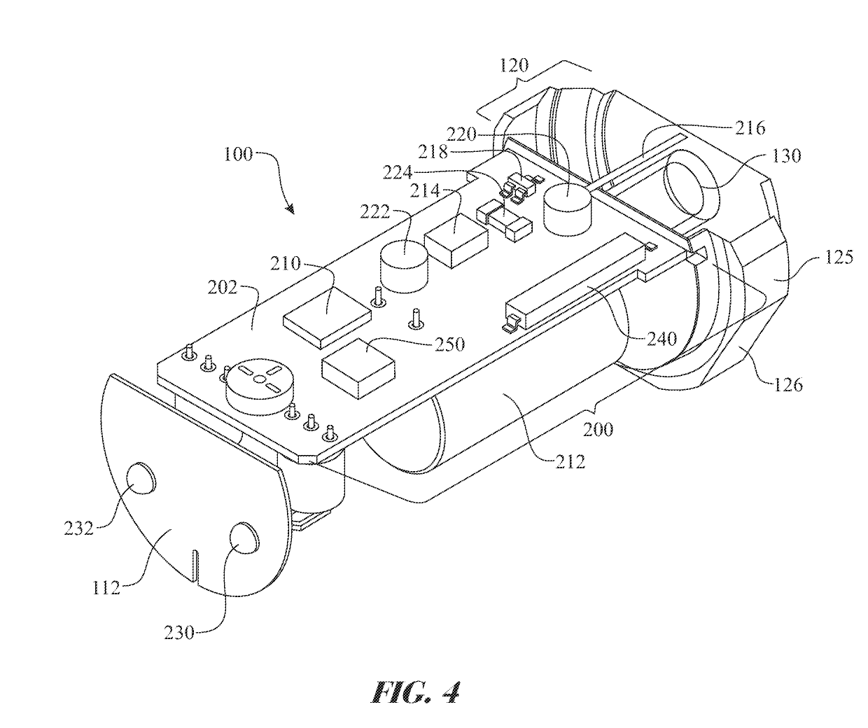

When assembled to one another, the sensing device enclosure 110 and base subassembly 120 form an internally enclosed volume for retaining and protecting a Printed Circuit Assembly (PCA) 200 (FIGS. 3 and 4). The assembly between the sensing device enclosure 110 and the base subassembly 120 can be accomplished using any known or inventive interface and/or assembly process for attaching a tubular member (representative of the sensing device enclosure 110) to a base member (representative of the base subassembly 120). This can include adhesives, epoxies, a threaded interface, a press fit interface, an interference interface, a snap fit interface, and the like. The assembly can be considered as permanent, such as a bonded interface, or removably attached, such as a threaded interface, a snap fit interface, and the like. A barcode label 140 having a barcode indicia 142 disposed thereon can be attached to the sensing device enclosure 110 in an accessible location, such as upon a sidewall (as shown) or upon a top surface (as understood by description). In an alternative embodiment, the barcode indicia 142 can be directly applied to the sensing device enclosure 110 using any suitable process, including printing, laser etching, and the like. It is preferred that the barcode indicia 142 be unique or reasonably unique enabling logging of data to a specific referenced device 100.

The Printed Circuit Assembly (PCA) 200 provides a majority of the operational functionality of the machine condition indicating sensor and monitoring device 100. The Printed Circuit Assembly (PCA) 200 includes a series of electronic components assembled to a Printed Circuit Board (PCB) 202. The Printed Circuit Board (PCB) 202 is fabricated having a network of electrically conductive elements, referred to as traces, extending in electrical communication between attachment pads arranged in a desired pattern. The pattern of traces in combination with the various components forms one or more electrical circuits. The electrical circuits accomplish the desired functions of the machine condition indicating sensor and monitoring device 100.

Power is supplied to the Printed Circuit Assembly (PCA) 200 by a portable power supply 212. The portable power supply 212 can be any portable power supply, with the preferred portable power supply being a battery. The exemplary portable power supply 212 is in electro-mechanical communication with the Printed Circuit Board (PCB) 202 by a plurality of leads 213 inserted through and attached to respective plated through holes 260 using a soldering process. One exemplary battery 212 is a lithium battery rated for long life. Lithium batteries are disposable (primary) batteries that utilize lithium metal or lithium compounds as an anode. The battery is usually sealed in epoxy. As such, battery replacement is not possible. The battery 212 is selected to provide power to the machine condition indicating sensor and monitoring device 100 for at least three (3) years of normal operation. This is conditional on the machine condition indicating sensor and monitoring device 100 encountering a single alarm event. It is understood that the battery life decreases proportionally with the number of alarm detections. Consequently, one can expect two (2) years of life with detection and indication of two (2) alarm events and one (1) year of life after with detection and indication of three (3) alarm events. The machine condition indicating sensor and monitoring device 100 must be manually reset after it detects an alarm condition. Therefore, if battery life permits, the machine condition indicating sensor and monitoring device 100 can be reset up to three (3) times before replacement is required.

A microprocessor 210 is assembled to the Printed Circuit Board (PCB) 202 using any known packaging form factor and respective assembly process. Digital memory can be integrated into the microprocessor 210 or provided by a separate component. Electrical circuit support components, such as transistors 218, a band pass filter 214, a demodulator 250, resistors (not shown), capacitors (not shown), inductors capacitors (not shown), and the like can be integrated into the Printed Circuit Assembly (PCA) 200 as needed. An instruction set, commonly known as software, firmware, or both is programmed into the microprocessor 210. The instruction set in conjunction with the microprocessor 210 provides intelligence, functionality, and operational control to the machine condition indicating sensor and monitoring device 100.

Data is obtained through a series of sensors 220, 222, and 224. Each sensor 220, 222, and 224 is provided in electrical communication with the Printed Circuit Board (PCB) 202 by any suitable conductive interface. The preferred configuration electro-mechanically assembles one or more of the sensors 220, 222, 224 directly to the Printed Circuit Board (PCB) 202 using either a lead-through hole interface 260 or a surface mount assembly interface. Alternatively, it is understood that one or more sensors 220, 222, and 224 can be mechanically integrated into the machine condition indicating sensor and monitoring device 100 at a location that is remote from the Printed Circuit Board (PCB) 202. In the remotely located configuration, wires would provide the conductive interface between the sensor 220, 222, and 224 and the Printed Circuit Board (PCB) 202. The first sensor 220 and/or second sensor 222 can sense at least one of a velocity, an enveloped acceleration and a temperature value of the bearing. The first sensor 220 and/or second sensor 222 can be in tern potted inside the interior defined by the sensing device enclosure 110 and base subassembly 120. Consequently, the health status of a bearing or similar rotational interface can be determined by input and feedback from one or more of the at least one sensors 220, 222, 224.

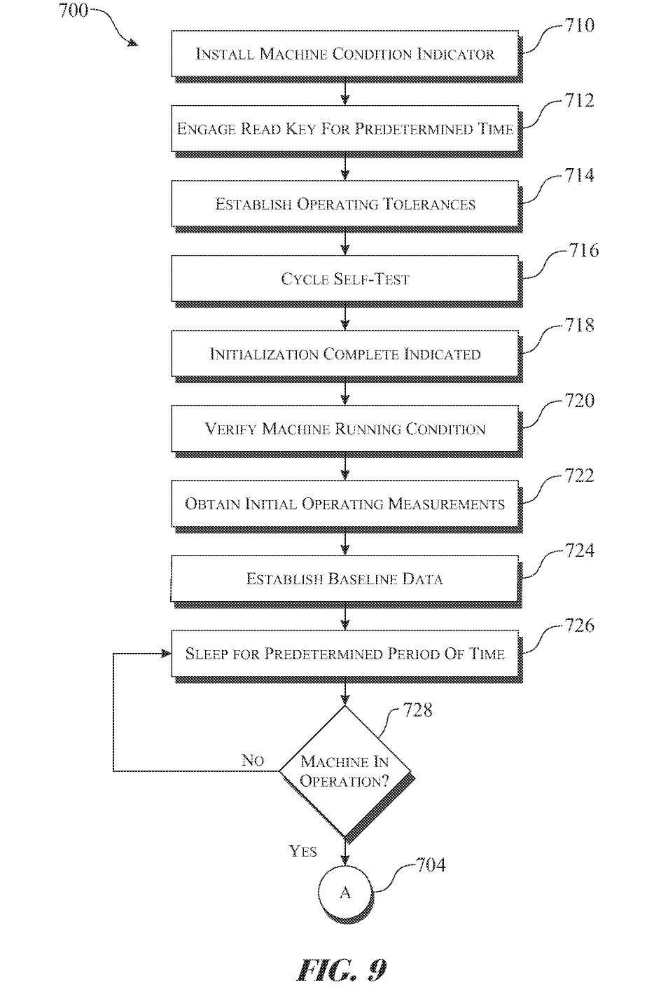

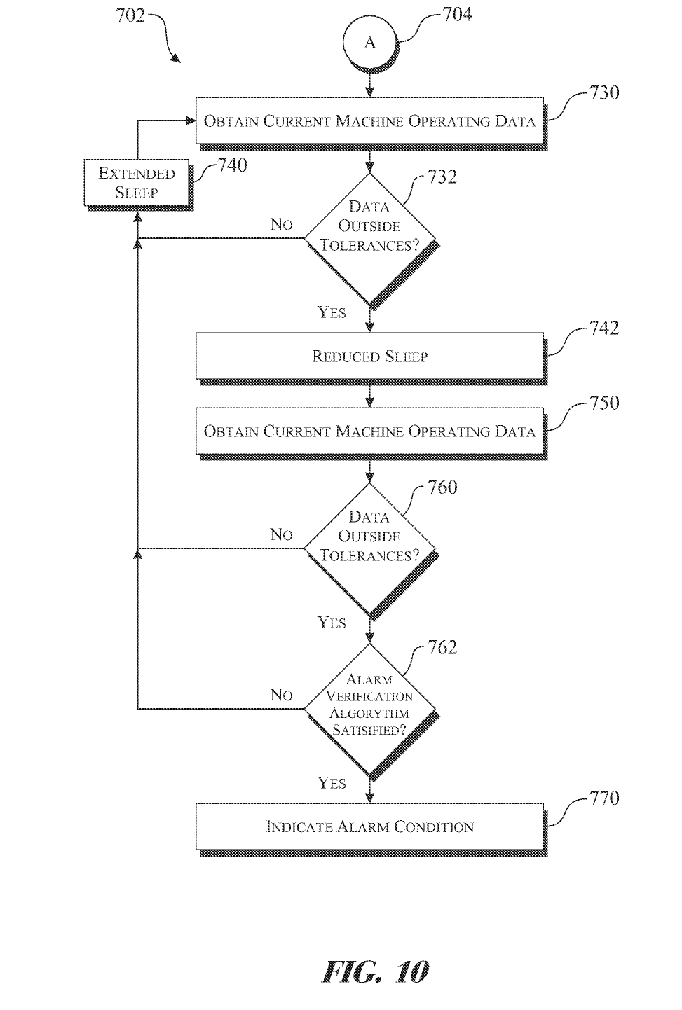

The microprocessor 210 includes a set of instructions to monitor the status of the rotational interface. The set of instructions includes a series of steps to determine a percentage difference from an established baseline data point to identify an alarming condition. Data from each sensor 220, 222, 224 is communicated to the microprocessor 210. The microprocessor 210 monitors data from each sensor 220, 222, 224 to determine a change in the monitoring operating characteristic, such as the velocity, acceleration, temperature, and the like. When the microprocessor 210 identifies a potential alarm condition, the microprocessor 210 continues to monitor the conditions of the rotating industrial machinery 410. The microprocessor 210 determines that the rotating industrial machinery 410 is in an alarm condition when a series of sequentially collected data points are above the calculated threshold. The set of instructions can include steps to modify the frequency for investigating the operating characteristics of the rotating industrial machinery 410. The frequency for investigating the operating characteristics of the rotating industrial machinery 410 would be increased upon identification that the operating characteristic(s) of the rotating industrial machinery 410 is either approaching or exceeds the calculated threshold. Details of this process are described by the exemplary percentage monitoring flow diagram 700 presented in FIGS. 9 and 10. Consequently, the health status of the bearing is determined by input and feedback from one of the at least one sensors 60.

In one embodiment, the sensors 220, 222 are temperature sensors 220, 222, which monitor temperature and provide a digital output representative of the temperature. Operating temperature of the rotational component(s) of the rotating industrial machinery 410 can be determined using any temperature monitoring process known by those skilled in the art. In the exemplary embodiment, a thermally conductive circuit board trace 216 can be integrated between a thermal contact point of the base subassembly 120 and the Printed Circuit Board (PCB) 202 providing thermal communication between the bearing raceway 310 and each respective sensor 220, 222. The thermally conductive circuit board trace 216 is fabricated of a thermally conductive material, such as copper, wherein the selected material would have a melting point significantly higher than the anticipated highest temperature generated by the rotating industrial machinery 410.

When the temperature sensor(s) 220, 222 identify a sufficient change in temperature the machine condition indicating sensor and monitoring device 100 transitions into a suspected alarm mode. In a first embodiment, the machine condition indicating sensor and monitoring device 100 includes a single temperature sensor 220. In an enhanced embodiment the machine condition indicating sensor and monitoring device 100 includes at least two sensors 220, 222 for correlation, redundancy, and overall improved performance. The at least two sensors 220, 222 can monitor the temperature of two or more separate items, such as ambient temperature and a machine operating temperature.

The sensor 224 would preferably function as an enveloped acceleration sensor (accelerometer) 224. When the enveloped acceleration sensor (accelerometer) 224 identifies a sufficient change in velocity or acceleration the machine condition indicating sensor and monitoring device 100 transitions into a suspected alarm mode. Velocity is calculated via the enveloped acceleration sensor (accelerometer) 224 or in conjunction with the microprocessor 210. A range in velocity, represented as an output of 10-1000 Kilohertz is within a normal sensing range. A range in enveloped acceleration of 900-3600 rpm and 1-4 G's is also within the range of the enveloped acceleration sensor (accelerometer) 224. It is also understood that data from the enveloped acceleration sensor (accelerometer) 224 can be used to determine vibrations generated by the rotating elements of the rotating industrial machinery 410.

Various components can be integrated into the Printed Circuit Assembly (PCA) 200 to improve the data collection process. The band pass filter 214 filters the signal and/or eliminates low frequency structural machinery vibrations signals developed in the operating environment. Inclusion of a demodulator 250 demodulates and enhances the frequency content at a bearing defect frequency. Consequently, the band pass filter 214 and demodulator 250 act to improve the frequency response of the enveloped acceleration sensor (accelerometer) 224.

The monitoring process of the Printed Circuit Assembly (PCA) 200 identifies an alarming condition or event. Upon identification and verification of an alarming condition, the machine condition indicating sensor and monitoring device 100 needs to include a feature to communicate the condition to an operator 440 (FIG. 6). The communication can be provided by any suitable alerting feature. One or more warning indicators are integrated into the Printed Circuit Assembly (PCA) 200. Since power consumption is a concern, the preferred alerting feature would be an illuminating device, such as a light emitting diode (commonly referred to as an LED). The exemplary embodiment includes three warning indicators, including a first light emitting diode 230, a second light emitting diode 232, and a third light emitting diode 234. In the exemplary embodiment, each of the three warning indicators 230, 232, 234 emits a unique color, including red, amber, and green. Each of the warning indicators 230, 232, 234 is supported by an annular top member 112. The warning indicators 230, 232, 234 can be inserted through the annular top member 112 or assembled to an exterior surface of the annular top member 112. An electrical interface provides electrical communication between each warning indicator 230, 232, 234 and the Printed Circuit Board (PCB) 202. Each exemplary warning indicator 230, 232, 234 is assembled to the Printed Circuit Board (PCB) 202 by a plurality of LED leads 236.

In an alternative embodiment, the warning indicator can utilize one or more tri-color or multi-color light emitting diode (LED). The illuminated color would depend upon a voltage applied to the respective LED 220, 222, 224. The voltage would direct illumination of the respective LED 220, 222, 224 to a specific illumination wavelength, including red, green or translucent. Normally, the at least one tri-color LED functions to illuminate red or green. However, the LED used in the present invention is configured to illuminate translucent as well. In this case, the LED is energized to illuminate both red and green. The net affect of illuminating both red and green simultaneously creates an amber illumination.

Protection from the environment can be provided by any method known by those skilled in the art. The combination of the sensing device enclosure 110, annular top member 112, and base subassembly 120 provides an environmental barrier protecting the Printed Circuit Assembly (PCA) 200. The design of the machine condition indicating sensor and monitoring device 100 can include an optional sealing feature to isolate the Printed Circuit Assembly (PCA) 200 from the environment. In one embodiment, a LED seal 238 can be assembled about each of the warning indicators 230, 232, 234, creating an environmental seal between each warning indicator 230, 232, 234 and a respective aperture passing through the annular top member 112. In an alternative embodiment, a lens (not shown) can be integrated into the machine condition indicating sensor and monitoring device 100, wherein the lens covers the warning indicators 230, 232, 234.

Programming of the machine condition indicating sensor and monitoring device 100 can be accomplished by a magnetic coded key 150. The magnetic coded key 150 wirelessly interacts with a magnetic read device 240 of the Printed Circuit Assembly (PCA) 200 using a key magnetic interface 154. The magnetic coded key 150 preferably includes a key grip 152, which is overmolded onto the key magnetic interface 154. The machine condition indicating sensor and monitoring device 100 is synchronized to a magnetic coded key 150. One of the at least one indicators 230, 232, 234 illuminates in a manner to indicate that the magnetic key has been read. In the exemplary embodiment, the respective indicator 230, 232, 234 illuminates a flashing red light for a predetermined period of time, such as ten (10) seconds.

When the magnetic coded key 150 is positioned proximate the machine condition indicating sensor and monitoring device 100, the machine condition indicating sensor and monitoring device 100 becomes activated. Subsequent to the activate, the machine condition indicating sensor and monitoring device 100 initiates a self-check procedure to verify proper functionality. Upon successful completion of the self-check procedure, one of the at least one indicators 230, 232, 234 illuminates in a manner to indicate that the self-check procedure was successful. In the exemplary embodiment, the respective indicator 230, 232, 234 illuminates a solid green light for a predetermined period of time, such as ten (10) seconds to indicate a successful self-check procedure. Should the self-check procedure fail at least one step, the one of the at least one indicators 230, 232, 234 illuminates in a manner to indicate that the self-check procedure has not successfully completed all of the self-check procedure steps. In the exemplary embodiment, the respective indicator 230, 232, 234 illuminates either a solid or flashing amber light for a predetermined period of time, such as ten (10) seconds to indicate a failure during the self-check procedure.

The machine condition indicating sensor and monitoring device 100 is programmed to wake up for a predetermined number of times over a 24 hour period in order to check if the industrial machine is in operation. Factory programming of the machine condition indicating sensor and monitoring device 100 would include instructions to wake up eight (8) times per day (every three (3) hours). The cycle time of the machine condition indicating sensor and monitoring device 100 can be modified by, either the manufacturer, a distributor, or the end user to meet a customer's requirements. After waking up, at least one sensor evaluation of at least one of the velocity and enveloped acceleration and current temperature level of the industrial rotating machine is initiated.

When the machine evaluation meets a pre-established minimum threshold, the device transitions into an alarm mode. The machine condition indicating sensor and monitoring device 100 can transition into an alarm verification mode, wherein the sensors 220, 222, 224 retry the measurements or resample the data to verify that the rotating industrial machinery 410 is current exhibiting the alarm condition. The machine condition indicating sensor and monitoring device 100 indicates an alarm condition by illuminating at least one of the warning indicators 220, 222, 224. It would be preferred to illuminate a red indicator upon verification of an alarm condition. The machine condition indicating sensor and monitoring device 100 can modified the sleep mode once an alarm condition is determined and verified. In one embodiment, the machine condition indicating sensor and monitoring device 100 can revise the sleep mode to place the device 100 into a sleep mode between illuminations of the alarm indicators 230, 232, 234. The machine condition indicating sensor and monitoring device 100 can optionally cease monitoring of the rotating industrial machinery 410 while emitting an alarm condition warning. The machine condition indicating sensor and monitoring device 100 can resume the monitoring process upon acknowledgement by an operator 440. In an alternative embodiment, upon identification of an alarm condition, the sleep mode of the machine condition indicating sensor and monitoring device 100 is modified to increase the frequency of data inquiries.

In a condition where the machine condition indicating sensor and monitoring device 100 determines that the data obtained during the sampling of the operating parameters of the rotating industrial machinery 410 is below a minimum alarm threshold, the machine condition indicating sensor and monitoring device 100 returns to a sleep mode. The machine condition indicating sensor and monitoring device 100 remains in a sleep mode, conserving power, until the end of the sleep cycle, wherein the machine condition indicating sensor and monitoring device 100 wakes up to repeat the machine status sampling process.

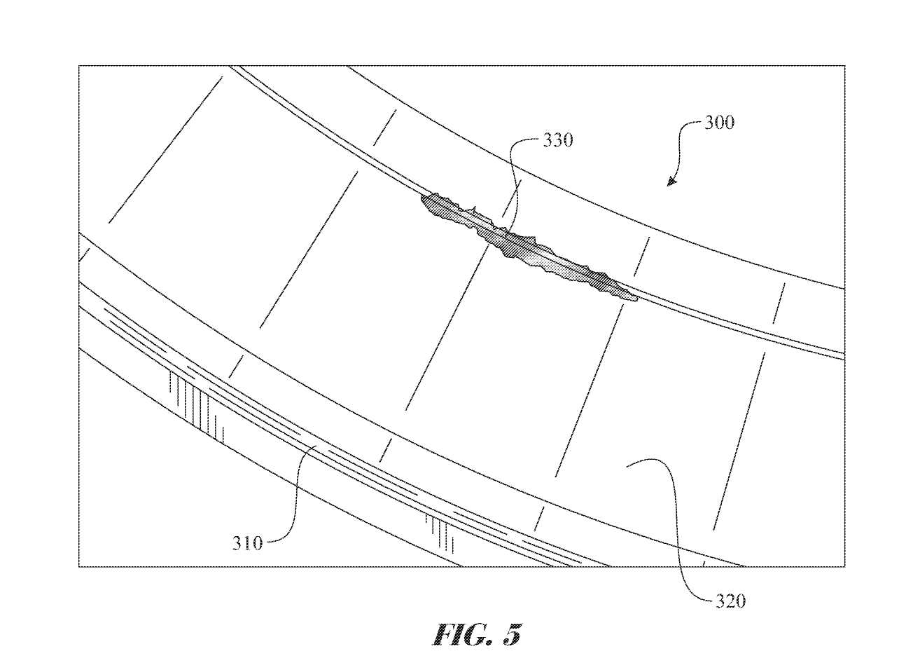

A stage 3 bearing defect 330 of a roller bearing 300, as illustrated in FIG. 5, can eventually case catastrophic failure. The machine condition indicating sensor and monitoring device 100 can be used to detect a stage 3 bearing defect 330 of a roller bearing 300 prior to a catastrophic failure. FIG. 5 shows a bearing raceway 310 having an inner surface 320 and stage 3 sidebanding defects 330. In the third stage of failure, bearing defect frequency levels increase and their harmonics appear on the spectrum. As wear progresses, sidebanding increases around the defect frequencies and can be seen more clearly as raised levels and harmonics in the mounted resonance area. The enveloped acceleration sensor (accelerometer) 224 can be used to determine harmonics, changes in velocity, unwarranted vibrations, and the like to detect the stage 3 bearing defect 330 of the roller bearing 300.

An exemplary operating environment 400 is illustrated in FIG. 6. The exemplary operating environment 400 includes a series of four rotating industrial machines 410. A machine condition indicating sensor and monitoring device 100 is integrated into each rotating industrial machine 410. Each machine condition indicating sensor and monitoring device 100 has a unique identifier that is associated with the respective rotating industrial machinery 410. Each rotating industrial machine 410 defines a checkpoint 412, 414, 416, 418, wherein each checkpoint is associated with a combination of the respective machine condition indicating sensor and monitoring device 100 and rotating industrial machinery 410. The checkpoints 412, 414, 416, 418 can be referred to as a first checkpoint 412, a second checkpoint 414, a third checkpoint 416, and a fourth checkpoint 417. The checkpoints 412, 414, 416, 418 are preferably arranged in numerical order along a predetermined route 420. Although the exemplary operating environment 400 includes four (4) rotating industrial machines 410, it is understood that the operating environment 400 can include any number of rotating industrial machines 410, wherein checkpoint 419 is representative of any number of rotating industrial machines 410.

An operator 440 would use an inspection device 450 to follow the predetermined route 420 and record data from each inspection device 450. The inspection device 450 includes barcode or other machine-readable indicia reader capable of scanning each barcode indicia 142 of each machine condition-indicating sensor and monitoring device 100. The operator 440 can enter additional information into a data recording device such as a status of each rotating industrial machinery 410 as indicated by the respective machine condition indicating sensor and monitoring device 100. By ensuring the operator conducts an inspection and records the status of each rotating industrial machinery 410, the operator driven reliability process guarantees each the plurality of machine condition indicating sensor and monitoring devices 100 has been checked by the operator 440.

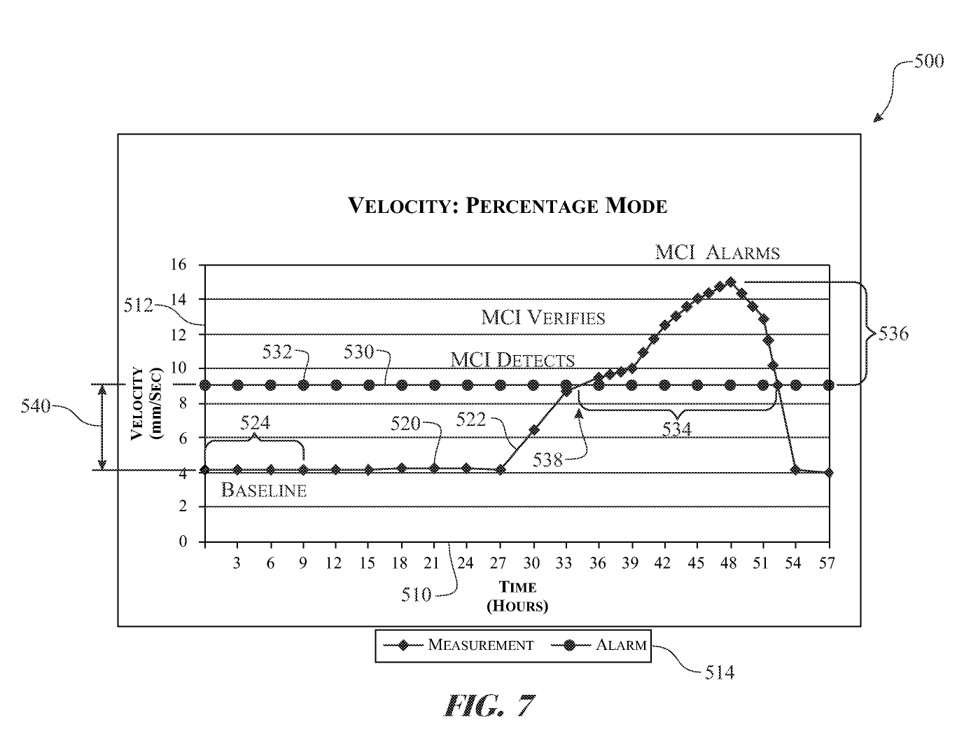

The machine condition indicating sensor and monitoring device 100 can be programmed to monitor the rotating industrial machinery 410 for changes using a percentage from a baseline. An exemplary velocity monitoring chart 500, presented in FIG. 7, demonstrates the manner in which the machine condition indicating sensor and monitoring device 100 determines an alarm condition. Initially, reference elements of the velocity monitoring chart 500 include a time axis 510 oriented along a horizontal base axis and a velocity axis 512 oriented along a vertical datum axis. A reference to the data is presented in a legend 514. The respective chart records the velocity in millimeters per second (mm/sec) and records the data against the period of time in which the data point was recorded.

In the exemplary embodiment, the enveloped acceleration sensor (accelerometer) 224 measures and records a velocity of the rotational element of the rotating industrial machinery 410. The machine condition indicating sensor and monitoring device 100 reads several initial data points 520 during a known acceptable condition to determine a baseline 524. In general, the data point for velocity is greater than 7 mm/s, while the data point for enveloped acceleration is greater than 4 gE and the data point for temperature is greater than 50 degrees C.

A monitored data point trend line 522 is drawn connecting each adjacent pair of monitored data points 520. The monitored data point trend line 522 presents a graphical representation of a trend of the status of the velocity of the rotating industrial machinery 410. Once the baseline 524 is established, the microprocessor 210 determines the acceptable limit of operation of the rotating industrial machinery 410. The acceptable limit of operation of the rotating industrial machinery 410 is determined by a formula utilizing a pre-established percent difference 540. A predetermined percentage delta 530 is presented in the velocity monitoring chart 500, wherein the predetermined percentage delta 530 is representative of the acceptable limit of operation of the rotating industrial machinery 410.

Alternatively, the acceptable limit of operation of the rotating industrial machinery 410 can be presented as a series of predetermined percentage delta reference points 532. In one example, the pre-established percent difference 540 would be 200% of the baseline reference. The machine condition indicating sensor and monitoring device 100 continues to measure the desired operating states of the rotating industrial machinery 410 and record the respective monitored data points 520. The microprocessor 210 monitors the recorded monitored data points 520 to determine if the trend is approaching the predetermined percentage delta 530 or if the data point has exceeded the predetermined baseline percentage delta 530. As the measured velocity of the rotational elements of the rotating industrial machinery 410 approaches the predetermined percentage delta 530, the machine condition indicating sensor and monitoring device 100 can increase the frequency of measurements in order to verify the operational condition of the rotating industrial machinery 410 is currently within an alarm condition. This is illustrated in the exemplary chart by the increased number of monitored data points 520 within the range of data points identified within the alarm condition 534. In a condition where the velocity exceeds the predetermined percentage delta 530 (identified by alarm condition transition data point 538), the machine condition indicating sensor and monitoring device 100 determines and subsequently verifies that the rotating industrial machinery 410 has entered a alarm condition 534 and the machine condition indicating sensor and monitoring device 100 transitions into an alerting state. Verification can be accomplished by measure subsequent operating condition parameters of the rotating industrial machinery 410 over a predetermined period of time, or over a predetermined number of repeated data points. The machine condition indicating sensor and monitoring device 100 would indicate an alarm by illuminating a respective light emitting diode 230, 232, 234. The preferred output would be a solid or flashing red light. The machine condition indicating sensor and monitoring device 100 can additionally determine a value exceeding acceptable range 536. The machine condition indicating sensor and monitoring device 100 can modify the output signal of the light emitting diode 230, 232, 234 to indicate the severity of the alarm based upon the value of the value exceeding acceptable range 536. It is understood that the machine condition indicating sensor and monitoring device 100 can identify a condition where the operating parameters of the rotating industrial machinery 410 are approaching the predetermined percentage delta 530 and identify the condition accordingly by illuminating a respective light emitting diode 230, 232, 234 to emit an amber light.

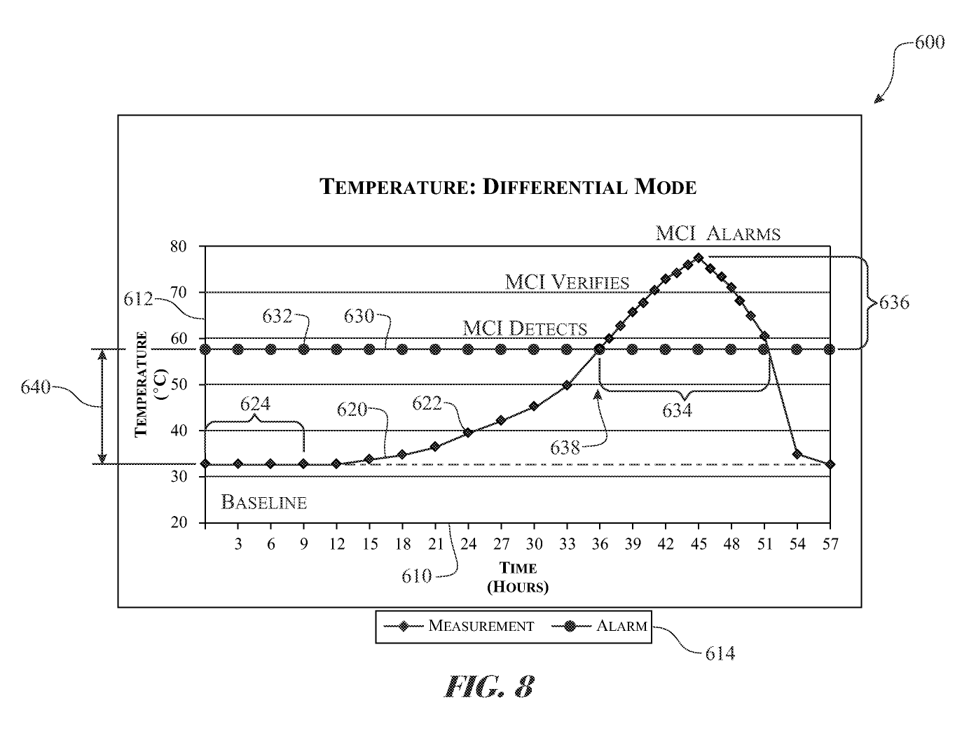

The machine condition indicating sensor and monitoring device 100 can be programmed to monitor the rotating industrial machinery 410 for changes using a quantified delta from a baseline. An exemplary temperature monitoring chart 600, presented in FIG. 8, demonstrates the manner in which the machine condition indicating sensor and monitoring device 100 determines an alarm condition using a quantified delta. Initially, reference elements of the temperature monitoring chart 600 include a time axis 610 oriented along a horizontal base axis and a temperature axis 612 oriented along a vertical datum axis. A reference to the data is presented in a legend 614. The respective chart records the temperature degrees Celsius and records the data against the period of time in which the data point was recorded.

In the exemplary embodiment, the temperature sensors 220, 222 measure and record a temperature of the rotating industrial machinery 410. The machine condition indicating sensor and monitoring device 100 reads several initial data points 620 during a known acceptable condition to determine a baseline 624. A monitored data point trend line 622 is drawn connecting each adjacent pair of monitored data points 620. The monitored data point trend line 622 presents a graphical representation of a trend of the status of the temperature of the rotating industrial machinery 410. Once the baseline 624 is established, the microprocessor 210 determines the acceptable limit of operation of the rotating industrial machinery 410. The acceptable limit of operation of the rotating industrial machinery 410 is determined by a formula utilizing a pre-established percent difference 640. A predetermined quantified percent difference 630 is presented in the temperature monitoring chart 600, wherein the predetermined percent difference 630 is representative of the acceptable limit of operation of the rotating industrial machinery 410. Alternatively, the acceptable limit of operation of the rotating industrial machinery 410 can be presented as a series of predetermined quantified delta reference points 632. In one example, the pre-established percent difference 640 would be 80% greater than the baseline reference 624. The machine condition indicating sensor and monitoring device 100 continues to measure the desired operating states of the rotating industrial machinery 410 and record the respective monitored data points 620. The microprocessor 210 monitors the recorded monitored data points 620 to determine if the trend is approaching the predetermined quantified percent difference 630 or if the data point has exceeded the predetermined baseline percentage delta 630. As the measured temperature of the rotating industrial machinery 410 approaches the predetermined quantified percent difference 630, the machine condition indicating sensor and monitoring device 100 can increase the frequency of measurements in order to verify the operational condition of the rotating industrial machinery 410 is currently within an alarm condition. This is illustrated in the exemplary chart by the increased number of monitored data points 620 within the range of data points identified within the alarm condition 634. In a condition where the temperature exceeds the predetermined quantified percent difference 630, (identified by alarm condition transition data point 638), the machine condition indicating sensor and monitoring device 100 determines and subsequently verifies that the rotating industrial machinery 410 has entered a alarm condition 634 and the machine condition indicating sensor and monitoring device 100 transitions into an alerting state. Verification can be accomplished by measure subsequent operating condition parameters of the rotating industrial machinery 410 over a predetermined period of time, or over a predetermined number of repeated data points. The machine condition indicating sensor and monitoring device 100 would indicate an alarm by illuminating a respective light emitting diode 230, 232, 234. The preferred output would be a solid or flashing red light. The machine condition indicating sensor and monitoring device 100 can additionally determine a value exceeding acceptable range 636. The machine condition indicating sensor and monitoring device 100 can modify the output signal of the light emitting diode 230, 232, 234 to indicate the severity of the alarm based upon the value of the value exceeding acceptable range 636. It is understood that the machine condition indicating sensor and monitoring device 100 can identify a condition where the operating parameters of the rotating industrial machinery 410 are approaching the predetermined quantified percent difference 630 and identify the condition accordingly by illuminating a respective light emitting diode 230, 232, 234 to emit an amber light.

The operational flow of the machine condition indicating sensor and monitoring device 100 is presented in the initialization portion of a percentage monitoring flow diagram 700 presented in FIG. 9 and continuing as monitoring and alarming portion of the percentage monitoring flow diagram 702, presented in FIG. 10. The process initiates by installing or attaching the machine condition indicating sensor and monitoring device 100 to the rotating industrial machinery 410 in a position to monitor a rotating element of the rotating industrial machinery 410 (block 710). Installation of the machine condition indicating sensor and monitoring device 100 can be accomplished using a threaded installation process, a bonding attachment process, and the like. Once installed, the machine condition indicating sensor and monitoring device 100 is configured for operation by engaging the key magnetic interface 154 of the magnetic coded key 150 with the magnetic read device 240 of the machine condition indicating sensor and monitoring device 100. The key magnetic interface 154 communicates with the magnetic read device 240 to program the microprocessor 210 accordingly (block 712). The programming process configures the machine condition indicating sensor and monitoring device 100 in accordance with the desired parameters, including setting the machine condition indicating sensor and monitoring device 100 in a percentage monitoring mode, a percentage limitation, an optional quantified delta limitation, a frequency of measurement periods, and the like (block 714). Once configured, the machine condition indicating sensor and monitoring device 100 executes a self-test cycle (block 716). In a condition where the machine condition indicating sensor and monitoring device 100 has successfully completed the self-test and initialization, the machine condition indicating sensor and monitoring device 100 indicates a successful completion of the self-test by illuminating a green light 220, 222, 224 (block 718). In a condition where the machine condition indicating sensor and monitoring device 100 has failed at least one step of the self test, the machine condition indicating sensor and monitoring device 100 indicates a failure of the self test by illuminating an amber or red light 220, 222, 224 (not shown). The machine condition indicating sensor and monitoring device 100 determines that the rotating industrial machinery 410 is currently in an operational condition (block 720). Once the machine condition indicating sensor and monitoring device 100 determines the rotating industrial machinery 410 is operational, the machine condition indicating sensor and monitoring device 100 measures and records initial datum points for the various monitored parameters (block 722). The various monitored parameters can include one or more temperatures, velocity, acceleration, and the like. The initial data points are utilized to establish a baseline (block 724). An acceptable limit is calculated using the pre-established parameters, preferably utilizing the percentage limitation, or alternatively using the quantified delta limitation. The machine condition indicating sensor and monitoring device 100 executes a sleep mode over a predetermined period of time (block 726). The sleep mode can be programmable and could be automatically modified upon recognition of a respective condition where a modification to the frequency of measurements would be warranted. Reaching exhaustion of the sleep period, the machine condition indicating sensor and monitoring device 100 wakes and investigates the operational condition of the rotating industrial machinery 410. The machine condition indicating sensor and monitoring device 100 determines if the rotating industrial machinery 410 is in an operational mode (decision block 728). In a condition where the machine condition indicating sensor and monitoring device 100 determines the rotating industrial machinery 410 is not in an operational mode, the machine condition indicating sensor and monitoring device 100 returns to the sleep mode (block 726). In a condition where the machine condition indicating sensor and monitoring device 100 determines the rotating industrial machinery 410 is currently in an operational mode, the machine condition indicating sensor and monitoring device 100 investigates, measures, and records datum points respective to the various monitored parameters of the rotating industrial machinery 410 (block 730). It is noted that a continuation block 704 is provided to establish continuity between the initialization portion of a percentage monitoring flow diagram 700 presented in FIG. 9 and the monitoring and alarming portion of the percentage monitoring flow diagram 702 presented in FIG. 10. The microprocessor 210 compares the measured and recorded current data points against the pre-established limits to determine if the rotating industrial machinery 410 is approaching or currently considered to be exhibiting an alarm condition (block 732). In a condition where the machine condition indicating sensor and monitoring device 100 determines the currently measured data points are within the acceptable range, the machine condition indicating sensor and monitoring device 100 returns to an extended sleep mode (block 740). The extended sleep mode (block 740) can have the same frequency as the original sleep mode (block 726), or the machine condition indicating sensor and monitoring device 100 can modify the sleep mode to decrease the frequency, thus extending the time between investigations. In a condition where the machine condition indicating sensor and monitoring device 100 determines the currently measured data points is approaching or has already exceeded the acceptable range, the machine condition indicating sensor and monitoring device 100 advanced to a reduced sleep mode (block 742). The reduced sleep mode (block 742) increases the frequency of measurements, thus decreasing the time between investigations. The machine condition indicating sensor and monitoring device 100 continues to monitor the status of the various predetermined parameters at the increased frequency rate to determine if the rotating industrial machinery 410 is approaching has already entered an alarm condition (block 750). After each successive measurement, the machine condition indicating sensor and monitoring device 100 determines if the data places the rotating industrial machinery 410 in an alarm condition, where the measured parameters are outside of the pre-established parameters (block 760). In a condition where the machine condition indicating sensor and monitoring device 100 determines that the most recently measured values are within acceptable limits, the machine condition indicating sensor and monitoring device 100 returns to the extended sleep mode (block 740). In a condition where the machine condition indicating sensor and monitoring device 100 determines that the most recently measured values exceed acceptable limits, the machine condition indicating sensor and monitoring device 100 repeats the measurement process to verify that the rotating industrial machinery 410 is confirmed to be in an alarm condition (block 762). It is noted that the confidence in an alarm condition can also be determined by the level or quantified value in which the condition exceeds the predetermined threshold level. The greater the delta, the higher the confidence of an alarm condition. Upon validation of an actual alarm condition, the machine condition indicating sensor and monitoring device 100 transforms into an alert mode, illuminating an alarm condition alert (block 770). The machine condition indicating sensor and monitoring device 100 would illuminate one of the light emitting diodes 230, 232, 234. The preferred illumination would be to emit a red light in either a solid or flashing mode. The illumination can be in accordance with a coded sequence to identify the specific alarm condition. It is understood that the machine condition indicating sensor and monitoring device 100 can illuminate one of the light emitting diodes 230, 232, 234 to emit a green light during normal operation to indicate the machine condition indicating sensor and monitoring device 100 is operational. Alternatively, the machine condition indicating sensor and monitoring device 100 can illuminate one of the light emitting diodes 230, 232, 234 to emit a green light during a measurement cycle to indicate the machine condition indicating sensor and monitoring device 100 is operational, while the machine condition indicating sensor and monitoring device 100 would leave the light emitting diodes 230, 232, 234 in an off configuration throughout the sleep mode.

Although the process can utilize a percentage to calculate the alarm indicating threshold 530, 630 it is understood that the threshold can be calculated using a quantified delta. The quantified delta would be added to the established baseline values 524, 624.

Alarm output can be coded, wherein the code can be provided to the operator 440 in any suitable format.

The alarm output can present a green light indicating an acceptable condition or acknowledgement of an event.

An internal alarm can be identified by emission of an amber light.

An enveloped acceleration alarm can be identified by emission of a red light in a single rotating sequence.

A velocity alarm can be identified by emission of a red light in a double rotating sequence.

A temperature alarm can be identified by emission of a red light in a triple rotating sequence.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

| Ref. | |
|---|---|
| No. | Description |
| 100 | machine condition indicating sensor and monitoring device |
| 110 | sensing device enclosure |
| 112 | annular top member |
| 120 | base subassembly |
| 122 | base seal |
| 124 | base seal element |
| 125 | installation tool interface |
| 126 | installation grip surfaces |
| 128 | base support and seal feature |
| 129 | PCB support slot |
| 130 | threaded through hole |
| 132 | base seal ring |
| 140 | barcode label |
| 142 | barcode indicia |
| 150 | magnetic coded key |
| 152 | key grip |
| 154 | key magnetic interface |
| 200 | Printed Circuit Assembly (PCA) |
| 202 | Printed Circuit Board (PCB) |
| 210 | microprocessor |
| 212 | portable power supply |
| 213 | power supply leads |
| 214 | band pass filter |
| 216 | thermally conductive circuit board trace |
| 218 | transistor |
| 220 | first sensor (temperature) |
| 222 | second sensor (temperature) |
| 224 | enveloped acceleration sensor (accelerometer) |
| 230 | first light emitting diode |
| 232 | second light emitting diode |
| 234 | third light emitting diode |
| 236 | LED leads |
| 238 | LED seal |
| 240 | magnetic read device |
| 250 | demodulator |
| 260 | plated through hole |
| 300 | roller bearing |
| 310 | bearing raceway |
| 320 | inner surface |
| 330 | stage side banding defects |
| 400 | operating environment |
| 410 | rotating industrial machinery |
| 412 | first checkpoint |
| 414 | second checkpoint |
| 416 | third checkpoint |
| 418 | fourth checkpoint |
| 419 | nth checkpoint |
| 420 | predetermined route |
| 440 | operator |
| 450 | inspection device |
| 500 | velocity monitoring chart |
| 510 | time axis |
| 512 | velocity axis |
| 514 | legend |
| 520 | monitored data points |
| 522 | monitored data point trend line |
| 524 | established baseline |
| 530 | predetermined percentage delta |
| 532 | predetermined percentage delta reference points |
| 534 | alarm condition |
| 536 | value exceeding acceptable range |
| 538 | alarm condition transition data point |
| 540 | predetermined difference |
| 600 | temperature monitoring chart |
| 610 | time axis |
| 612 | temperature axis |
| 614 | legend |
| 620 | monitored data points |
| 622 | monitored data point trend line |
| 624 | established baseline |
| 630 | predetermined quantified delta |
| 632 | predetermined quantified delta reference points |
| 634 | alarm condition |
| 636 | value exceeding acceptable range |
| 638 | alarm condition transition data point |
| 640 | predetermined difference |
| 700 | initialization portion of a percentage monitoring flow diagram |
| 702 | monitoring and alarming portion of the percentage monitoring |
| | flow diagram |
| 704 | continuation indicator |
| 710 | machine condition indicator installation step |
| 712 | engage read magnetic read key with machine condition indicator |
| 714 | establish operating tolerance(s) |
| 716 | execution of self test |
| 718 | indicate initialization complete |
| 720 | verify the machine is in an operational condition |
| 722 | obtain initial machine operating reference datum points |
| 724 | establish baseline reference |
| 726 | execute sleep mode over predetermined period of time |
| 728 | machine in operation decision |
| 730 | measure and record current machine operating state datum points |
| 732 | compare measured current data against established boundaries |
| 740 | execute extended sleep mode over predetermined extended period |
| | of time |
| 742 | execute reduced sleep mode over predetermined reduced period |
| | of time |
| 750 | measure and record current machine operating state datum points |
| 760 | compare measured current data against established boundaries |
| 762 | alarm verification algorithm decision |
| 770 | indicate alarm condition |

What is claimed is:

1. A method of monitoring a condition of at least one rotating component of a rotating machine, the method comprising steps of:
installing a machine condition indicating sensor and monitoring device (100) onto a rotating machine (410) (block 710), said device (100) comprising:
a sensor housing comprising a base subassembly (120) and an upper enclosure (110),
a printed circuit assembly (200) comprising components assembled to a printed circuit board (202) defining an operational circuit, said components include a microprocessor (210), a digital memory component (210), a portable power supply (212), at least one condition sensor (220, 222, 224), and an instruction set (embedded within 210), wherein said instruction set directs operation of said circuit by said microprocessor (210);
obtaining at least one data point of at least one operating characteristic of the respective rotating component to determine an initial baseline of each of the at lease one operating characteristic of said rotating machine (410) (block 722);
establishing a threshold, wherein the threshold is calculated as a percentage difference from the respective baseline;
storing said initial baseline (524, 624) within said memory component (210) (block 724);
monitoring each respective at least one operating characteristic of said rotating component during operation of said rotating machine (410) (block 730);
comparing a currently obtained operating condition data point of each said respective at least one operating characteristic of said respective rotating component against said calculated threshold (524, 624) to determine if the currently obtained condition is one of approaching an alarm condition and exceeding an alarm condition (decision block 732); and
based upon said output of said comparison between said currently obtained condition data point and said respective stored baseline data value, proceeding with one of:
in a condition where said percentage difference is less than said calculated threshold, said machine condition indicating sensor and monitoring device continues to monitor conditions of said respective rotating component, and
in a condition where said percentage difference is greater than said calculated threshold, said machine condition indicating sensor and monitoring device indicates an alarming condition.

2. A method of monitoring a condition of at least one rotating component of a rotating machine as recited in claim 1, the method further comprising a step of:
illuminating an illuminating element when said machine condition indicating sensor and monitoring device indicates an alarming condition (block 770).

3. A method of monitoring a condition of at least one rotating component of a rotating machine as recited in claim 1, said the method further comprising a step of:
upon initial identification of an alarm condition, repeating said step of obtaining said at least one operating condition parameter of said respective rotating component during operation of said rotating machine (410) to validate said alarm condition (block 762), and upon identification of successive data points having a value that exceeds said calculated threshold, establishing said alarm condition and subsequently activating an alarm indicator.

4. A method of monitoring a condition of at least one rotating component of a rotating machine as recited in claim 1, said the method further comprising a step of:
programming said microprocessor (210) using a wireless communication process (block 712).

5. A method of monitoring a condition of at least one rotating component of a rotating machine as recited in claim 4, wherein said wireless communication process is accomplished using a magnetic read key (150) and a respective magnetic read device (240) (block 712).

6. A method of monitoring a condition of at least one rotating component of a rotating machine as recited in claim 1, said the method further comprising a step of:
monitoring said at least one of said velocity, said acceleration, and said temperature of said respective rotating component during operation of said rotating machine (410) in accordance with a frequency of data inquiries, wherein said frequency comprises a sleep mode between each sequential data inquiry, wherein said sleep mode places said operational circuit into a dormant, low power consumption configuration.

7. A method of monitoring a condition of at least one rotating component of a rotating machine as recited in claim 6, said the method further comprising a step of:
increasing said frequency of data inquiries when said operational circuit one of approaches an alarm condition and exceeds said alarm condition.

8. A method of monitoring a condition of at least one rotating component of a rotating machine, the method comprising steps of:
installing a machine condition indicating sensor and monitoring device (100) onto a rotating machine (410) (block 710), said device (100) comprising:
a sensor housing comprising a base subassembly (120) and an upper enclosure (110),
a printed circuit assembly (200) comprising components assembled to a printed circuit board (202) defining an operational circuit, said components include a microprocessor (210), a digital memory component (210), a portable power supply (212), at least one condition sensor (220, 222, 224), and an instruction set (embedded within 210), wherein said instruction set directs operation of said circuit by said microprocessor (210);
obtaining at least one data point of at least one operating characteristic of the respective rotating component to determine an initial baseline of at least one of a velocity (524), acceleration (524), and a temperature (624) of a respective rotating component of said rotating machine (410) (block 722);
storing said initial baseline (524, 624) within said memory component (210) (block 724);
establishing a threshold, wherein the threshold is calculated as a percentage difference from the respective baseline;
monitoring said at least one of said velocity, said acceleration, and said temperature of said respective rotating component during operation of said rotating machine (410) (block 730);
comparing currently obtained condition data of said at least one of said velocity, said acceleration, and said temperature of said respective rotating component against said calculated threshold (530, 630) for each of said at least one of said velocity, said acceleration, and said temperature of said respective rotating component to determine if said currently obtained condition is one of approaching said alarm condition and exceeding said alarm condition (decision block 732); and
based upon said output of said comparison between said currently obtained condition data and said respective stored baseline data, proceeding with one of:
in a condition where said percentage difference is less than said calculated threshold, said machine condition indicating sensor and monitoring device continues to monitor conditions of said respective rotating component, and
in a condition where said percentage difference is greater than said calculated threshold, said machine condition indicating sensor and monitoring device indicates an alarming condition.

9. A method of monitoring a condition of at least one rotating component of a rotating machine as recited in claim 8, the method further comprising a step of:
illuminating an illuminating element when said machine condition indicating sensor and monitoring device indicates an alarming condition (block 770).

10. A method of monitoring a condition of at least one rotating component of a rotating machine as recited in claim 8, said the method further comprising a step of:
upon initial identification of an alarm condition, repeating said step of obtaining said at least one of said velocity, said acceleration, and said temperature of said respective rotating component during operation of said rotating machine (410) to validate said alarm condition (block 762), and upon identification of successive data points having a value that exceeds said calculated threshold, establishing said alarm condition and subsequently activating an alarm indicator.

11. A method of monitoring a condition of at least one rotating component of a rotating machine as recited in claim 8, said the method further comprising a step of:
programming said microprocessor (210) using a wireless communication process (block 712).

12. A method of monitoring a condition of at least one rotating component of a rotating machine as recited in claim 11, wherein said wireless communication process is accomplished using a magnetic read key (150) and a respective magnetic read device (240) (block 712).

13. A method of monitoring a condition of at least one rotating component of a rotating machine as recited in claim 8, wherein said at least one condition sensor (220, 222, 224) includes at least one temperature sensor (220, 222), said the method further comprising a step of:
monitoring a temperature of said rotating machine (410) by thermally coupling said base subassembly 120 to said rotating machine (410); and
thermally coupling said base subassembly 120 and at least one temperature sensor (220, 222) to one another.

14. A method of monitoring a condition of at least one rotating component of a rotating machine as recited in claim 8, said the method further comprising a step of:
monitoring said at least one of said velocity, said acceleration, and said temperature of said respective rotating component during operation of said rotating machine (410) in accordance with a frequency of data inquiries, wherein said frequency comprises a sleep mode between each sequential data inquiry, wherein said sleep mode places said operational circuit into a dormant, low power consumption configuration.

15. A method of monitoring a condition of at least one rotating component of a rotating machine as recited in claim 14, said the method further comprising a step of:
increasing said frequency of data inquiries when said operational circuit one of approaches an alarm condition and exceeds said alarm condition.

16. A method of monitoring a condition of at least one rotating component of a rotating machine, the method comprising steps of:
installing a machine condition indicating sensor and monitoring device (100) onto a rotating machine (410) (block 710), said device (100) comprising:
a sensor housing comprising a base subassembly (120) and an upper enclosure (110),
a printed circuit assembly (200) comprising components assembled to a printed circuit board (202) defining an operational circuit, said components include a microprocessor (210), a digital memory component (210), a portable power supply (212), at least one accelerometer (224), and an instruction set (embedded within 210), wherein said instruction set directs operation of said circuit by said microprocessor (210);
obtaining at least one data point of at least one of a velocity (524) and acceleration (524) to determine an initial baseline of at least one of a velocity (524) and an acceleration (524) of a respective rotating component of said rotating machine (410) (block 722);
storing said initial baseline (524, 624) within said memory component (210) (block 724);
establishing a threshold, wherein the threshold is calculated as a percentage difference from the respective baseline;
monitoring said at least one of said velocity, said acceleration, and said temperature of said respective rotating component during operation of said rotating machine (410) (block 730);
comparing currently obtained condition data of said at least one of said velocity and said acceleration of said respective rotating component against said calculated threshold (530) for each of said at least one of said velocity and said acceleration of said respective rotating component to determine if the currently obtained condition is one of approaching an alarm condition and exceeding an alarm condition (decision block 732); and
based upon said output of said comparison between said currently obtained condition data and said respective stored baseline data, proceeding with one of:
in a condition where said quantified difference is less than v, said machine condition indicating sensor and monitoring device continues to monitor conditions of said respective rotating component, and
in a condition where said quantified difference is greater than the calculated threshold, said machine condition indicating sensor and monitoring device indicates an alarming condition.

17. A method of monitoring a condition of at least one rotating component of a rotating machine as recited in claim 16, the method further comprising a step of:
illuminating an illuminating element when said machine condition indicating sensor and monitoring device indicates an alarming condition (block 770).

18. A method of monitoring a condition of at least one rotating component of a rotating machine as recited in claim 16, said the method further comprising a step of:
upon initial identification of an alarm condition, repeating said step of obtaining said at least one of said velocity and said acceleration of said respective rotating component during operation of said rotating machine (410) to validate said alarm condition (block 762), and upon identification of successive data points having a value that exceeds said calculated threshold, establishing said alarm condition and subsequently activating an alarm indicator.

19. A method of monitoring a condition of at least one rotating component of a rotating machine as recited in claim 16, said the method further comprising a step of:
programming said microprocessor (210) using a wireless communication process (block 712).

20. A method of monitoring a condition of at least one rotating component of a rotating machine as recited in claim 19, wherein said wireless communication process is accomplished using a magnetic read key (150) and a respective magnetic read device (240) (block 712).

21. A method of monitoring a condition of at least one rotating component of a rotating machine as recited in claim 16, the method further comprising a step of:
determining a velocity of said rotating element by measuring said acceleration of said rotating member.

22. A method of monitoring a condition of at least one rotating component of a rotating machine as recited in claim 16, said the method further comprising a step of:
monitoring said at least one of said velocity, said acceleration, and said temperature of said respective rotating component during operation of said rotating machine (410) in accordance with a frequency of data inquiries, wherein said frequency comprises a sleep mode between each sequential data inquiry, wherein said sleep mode places said operational circuit into a dormant, low power consumption configuration.

23. A method of monitoring a condition of at least one rotating component of a rotating machine as recited in claim 22, said the method further comprising a step of:
increasing said frequency of data inquiries when said operational circuit one of approaches an alarm condition and exceeds said alarm condition.
